(19) United States
(12) Patent Application Publication
(10) Pub. No.: US 2012/0050155 A1
(43) Pub. Date: Mar. 1, 2012

(54) IMAGING APPARATUS AND CONTROL METHOD THEREOF

(75) Inventors: Kazuhiro Watanabe, Tokyo (JP); Wataru Kaku, Yokohama-shi (JP); Osamu Sakata, Yokohama-shi (JP); Daijirou Nagasaki, Kamakura-shi (JP); Kaoru Konishi, Tokyo (JP); Satoshi Shinata, Tokyo (JP)

(73) Assignee: CANON KABUSHIKI KAISHA, Tokyo (JP)

(21) Appl. No.: 13/192,298

(22) Filed: Jul. 27, 2011

(30) Foreign Application Priority Data
Sep. 1, 2010 (JP) 2010-195856

(51) Int. Cl. G09G 5/00

(52) U.S. Cl. 345/156

(57) ABSTRACT

In an operation of a GUI member, operation feeling as if a user is operating a real object is realized. An imaging unit captures fingers of an operator. A system control unit detects the finger portion from the image captured by the imaging unit. The system control unit combines images in such a manner that the GUI member is positioned on a finger portion of a palm side and a finger portion of a backside is positioned on the GUI member from the image of the finger portions detected from the captured image, and displays the combined image on a display unit.

### BACKGROUND OF THE INVENTION

1. Field of the Invention

The present invention relates to an imaging apparatus and a control method thereof, allowing a user to perform a graphical user interface (GUI) operation such as instruction, selection, or movement of a GUI member displayed on a screen.

2. Description of the Related Art

According to a well-known operation method for performing instruction, selection, or movement on a GUI member, such as a thumbnail image recorded by an imaging apparatus, displayed on a screen by a user, a pointer or a cursor displayed on the screen is operated with a hardware member such as a button or a rotational dial. Further, such a method is well-known in which a user touches an image displayed on a touch panel to perform the operation.

Japanese Patent Application Laid-Open No. 2001-243012 discusses a method for selecting a GUI member which seems to be fixed on neighboring landscape on the display screen of an imaging apparatus by directing the imaging apparatus to a desired GUI member by a user.

Japanese Patent Application Laid-Open No. 2005-316403 discusses a technique for displaying an image selected from recorded images of an imaging apparatus in a partial area of a display device determined based on a relative positional relation between the imaging apparatus and the display device.

There is a problem that, when a user performs an operation by using a hardware member such as a button or a rotational dial, a user cannot intuitively operate the GUI member. According to the method discussed in Japanese Patent Application Laid-Open No. 2001-243012 or 2005-316403, the user performs the GUI operation by moving the main body of the imaging apparatus, and the sense for touching the GUI member is poor and the intuitive feeling deteriorates.

### SUMMARY OF THE INVENTION

The present invention is directed to an imaging apparatus, a control method thereof, a program, and a recording medium capable of intuitively operating a GUI member as if the user is touching a real object by the user's hand with a generally provided hardware member.

According to an aspect of the present invention, an imaging apparatus includes an imaging unit, a detection unit configured to detect a portion of a thumb and a finger from an image captured by the imaging unit, and a display control unit configured to display, on a display unit, a combined image generated to set a GUI member on a finger portion on a palm side and further set a portion of the thumb on a back side above the GUI member from the image of the portion of the thumb and finger detected by the detection unit.

According to another aspect of the present invention, the GUI member is displayed to touch the palm side of the fingers of a user. Therefore, intuitive operability is realized by the GUI member as if the user is touching with the user's hand a real object.

This summary of the invention does not necessarily describe all necessary features so that the invention may also be a sub-combination of these described features.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an external view according to a first exemplary embodiment.

FIG. 2 is a block diagram illustrating a schematic configuration of a digital camera.

FIG. 3 illustrates examples of composite images according to the first exemplary embodiment.

FIG. 4 is a schematic diagram illustrating a method for combining an image of fingers on the palm side, a GUI member, and an image of the fingers on the back side.

FIG. 5 is a processing flow of composition display according to the first exemplary embodiment.

FIG. 6 illustrates display examples of using estimation of the fingers according to a second exemplary embodiment.

FIG. 7 illustrates display examples of using nail detection according to a third exemplary embodiment.

FIG. 8 illustrates a display example of enlarging and reducing the GUI member according to enlargement and reduction of fingers according to a fourth exemplary embodiment.

FIG. 9 illustrates display examples of displaying a GUI member according to a focusing state focused on fingers according to a fifth exemplary embodiment.

### DESCRIPTION OF THE EMBODIMENTS

Various exemplary embodiments, features, and aspects of the invention will be described in detail below with reference to the drawings.

It is to be noted that the following exemplary embodiment is merely one example for implementing the present invention and can be appropriately modified or changed depending on individual constructions and various conditions of apparatuses to which the present invention is applied. Thus, the present invention is in no way limited to the following exemplary embodiment.

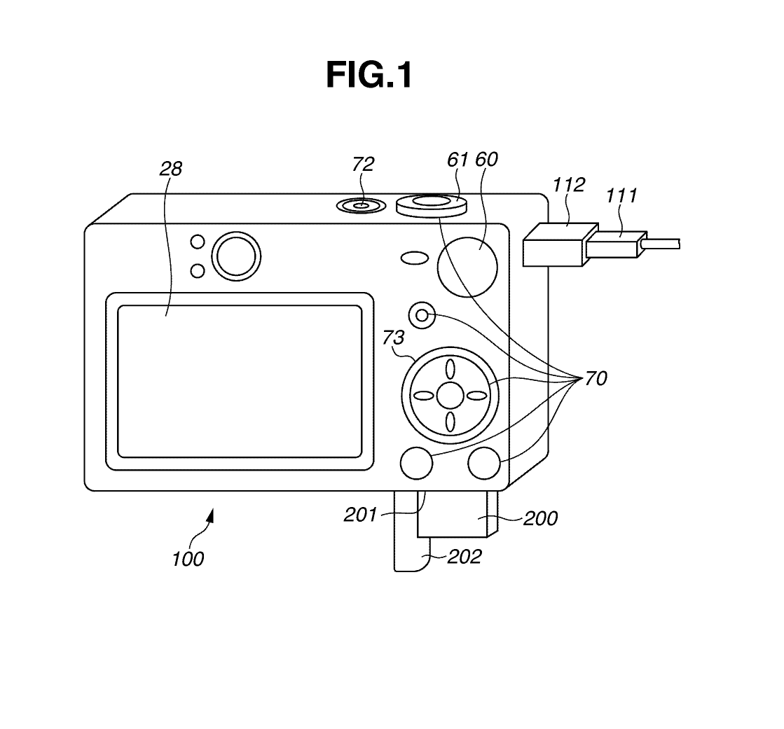

FIG. 1 illustrates an external view of a digital camera as an imaging apparatus according to a first exemplary embodiment of the present invention. A display unit 28 displays images or various kinds of information. A shutter button 61 is used to instruct image capturing. A mode changing switch 60 is an operation unit for changing various modes.

A connector 112 connects a connection cable and a digital camera 100. An operation unit 70 includes various switches for receiving various operations from a user, and operation members such as a button and a touch panel. A controller wheel 73 is a rotatable operation member included in the operation unit 70. A power switch 72 switches power ON and OFF.

A recording medium 200 is a recording medium such as a memory card or a hard disk. The recording medium 200 can be mounted in a recording medium slot 201. The recording medium 200 mounted in the recording medium slot 201 is communicable with the digital camera 100. A lid 203 is a lid for the recording medium slot 201.

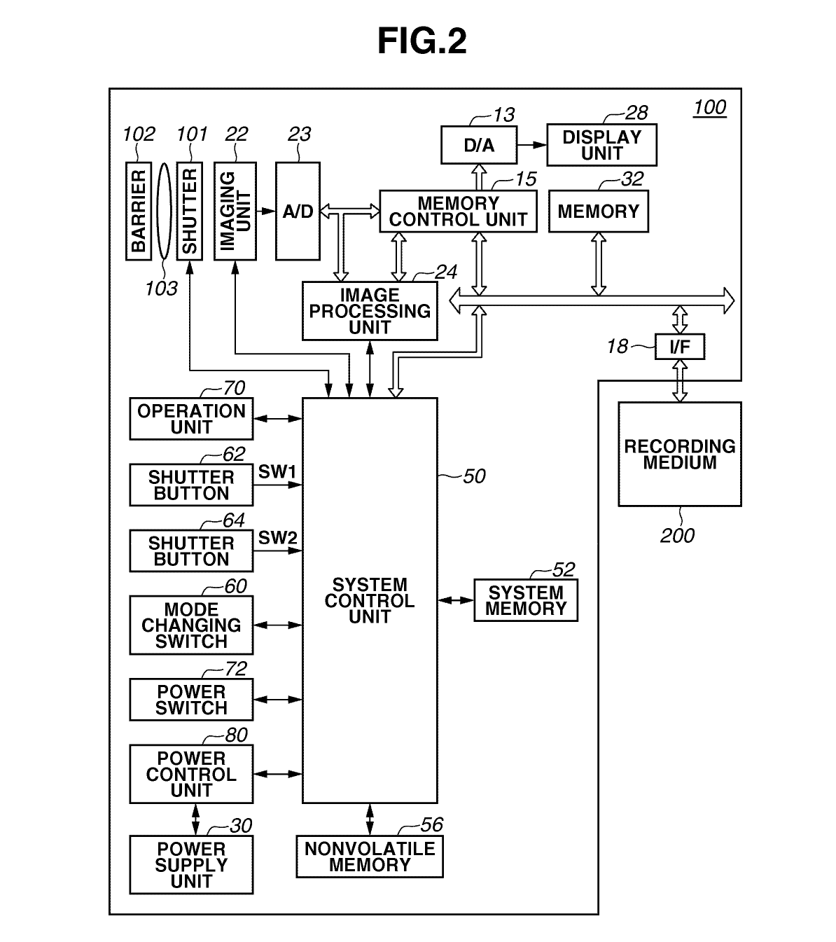

FIG. 2 is a block diagram illustrating the schematic configuration of the digital camera 100. A shooting lens 103 includes a focusing lens. A shutter 101 has a diaphragm function. An imaging unit 22 is configured with a charge coupled device (CCD) imaging device or a complementary metal-oxide semiconductor (CMOS) imaging device that converts an optical image into an electrical signal. An A/D converter 23 converts an analog signal output from the imaging unit 22 into a digital signal. A barrier 102 covers the imaging unit 22 including the shooting lens 103 of the digital camera 100, thereby protecting an imaging system including the shooting lens 103, the shutter 101, and the imaging unit 22 from a taint or damage.

An image processing unit 24 performs resize processing or color conversion processing such as a predetermined pixel interpolation or reduction of data from the A/D converter 23 or data from a memory control unit 15.

The image processing unit 24 performs predetermined arithmetic processing by using the captured image data. The system controller unit 50 controls exposure and focusing based on the obtained arithmetic operation result, thereby performing autofocus (AF) processing of a through-the-lens (TTL) system, automatic exposure (AE) processing, and electronic flash pre-emission (EF) processing.

The image processing unit 24 further performs predetermined arithmetic processing by using the captured image data, and further performs automatic white balance (AWB) processing of the TTL system based on the obtained arithmetic operation result.

Output data from the A/D converter 23 is directly written to a memory 32 via the image processing unit 24 and the memory control unit 15 or via the memory control unit 15. The memory 32 stores the image data that is obtained by the imaging unit 22 and is converted into the digital data by the A/D converter 23, and image data for displaying on a display unit 28.

The memory 32 has a sufficient storage capacity for storing a predetermined number of still images, a motion image for a predetermined time, and sound.

The memory 32 also has a function of a memory (video memory) for image displaying. A D/A converter 13 converts data for image displaying stored in the memory 32 into an analog signal, and supplies the converted analog signal to the display unit 28.

The image data for displaying written in the memory 32 is displayed on the display unit 28 via the D/A converter 13. The display unit 28 displays data on a display such as a liquid crystal display (LCD) according to the analog signal from the D/A converter 13.

A nonvolatile memory 56 is electrically erasable or recordable, and includes, e.g., an electrically erasable programmable read-only memory (EEPROM). The nonvolatile memory 56 stores constants or programs for operation of the system controller unit 50. The program is a control program that realizes various flowcharts, which will be described below.

The system control unit 50 controls the entire digital camera 100. The program recorded in the nonvolatile memory 56 is executed to realize processing. A system memory 52 is a random access memory (RAM).

Constants and variables for operation of the system controller unit 50 and a program read from the nonvolatile memory 56 are rasterized on the system memory 52. The system controller unit 50 controls the display operation by controlling the memory 32, the D/A converter 13, and the display unit 28.

The mode changing switch 60, a first shutter switch 62, a second shutter switch 64, and the operation unit 70 are operation units for inputting various operation instructions to the system controller unit 50.

The mode changing switch 60 switches the operation mode of the system controller unit 50 to any of a still-image recording mode, a motion-image recording mode, and a playback mode. The first shutter switch 62 is ON by the halfway of operation, i.e., half-press (for instructing the shooting preparation) of the shutter button 61 provided on the digital camera 100, and generates a first shutter switch signal SW1.

The system controller unit 50 starts the operations such as the AF processing, AE processing, AWB processing, and EF processing in response to the first shutter switch signal SW1.

The second shutter switch 64 is ON by the operation completion, i.e., full-press (shooting instruction) of the shutter button 61, and generates a second shutter switch signal SW2. The system controller unit 50 starts the operation of a series of image-capturing processing from signal reading from the imaging unit 22 to writing of image data in the recording medium 200 in response to the second shutter switch signal SW2.

A predetermined operation member of the operation unit 70 is operated as various functional buttons with assignment of functions depending on the scene by selecting and operating various functional icons displayed on the display unit 28. The functional button includes, e.g., an end button, a back button, an image advancing button, a jump button, a refine button, and an attribute change button.

When the menu button is pressed, the display unit 28 displays a menu screen for various setting. A user executes various setting intuitively by using the menu screen, a four-directional button, and a set button displayed on the display unit 28.

The controller wheel 73 is an operation member that is rotatable, included in the operation unit 70, and is used for designating a selection item together with the directional button.

The controller wheel 73 is rotated, thereby generating an electrical pulse signal according to an amount of operation. The system controller unit 50 controls the various units in the digital camera 100 based on the pulse signal. The system controller unit 50 counts the number of pulse signals, thereby determining the angle and the number of rotations of the controller wheel 73.

The controller wheel 73 may be any operation member that detects the rotation amount. For example, the controller wheel 73 may be a dial operation member that generates a pulse signal by rotation thereof according to the rotation by the user.

Alternatively, the controller wheel 73 may be an operation member including a touch sensor, and may be a touch wheel that detects the rotation of the finger of the user on the controller wheel 73 without the rotation thereof.

A power control unit 80 includes a battery detection circuit, a DC/DC converter, and a switch circuit for switching energization blocks, and detects the presence or absence of battery mounting, the type of battery, or remaining battery capacity.

The power control unit 80 controls the DC/DC converter based on the detection result and an instruction from the system controller unit 50, and supplies a required voltage to each unit including the recording medium 200 for a necessary period.

A power supply unit 30 includes a primary battery such as an alkaline battery or lithium battery, a secondary battery such as a NiCd battery, NiMH battery, or Li battery, or an AC adapter. An interface 18 is the interface with the recording medium 200. The recording medium 200 is, e.g., a memory card, and includes a semiconductor memory or a magnetic disk.

The digital camera 100 includes a detection unit that detects a portion of the fingers from a captured image. The detection unit is described. The system controller unit 50 transmits the image data as a detection target to the image processing unit 24.

Under control of the system controller unit 50, the image processing unit 24 applies a horizontal band-pass filter to the input image data. Under control of the system controller unit 50, the image processing unit 24 further applies a vertical band-pass filter to the processed image data. With the horizontal and vertical band-pass filters, an edge component is detected from the image data.

Then, the system controller unit 50 performs pattern matching on the detected edge component, and extracts candidates of the fingers. The system controller unit 50 detects the palm side and the back side of the fingers from the extracted candidates with preset detection conditions. The detection conditions include, e.g., the presence or absence of the nail and the bending direction of the joint.

The system controller unit 50 and the image processing unit 24 function in cooperation with each other, as a detection unit for detecting the portion of the fingers from the captured image. The system controller unit 50 outputs detection information indicating the detection result of the thumb and finger and ends the processing.

The hand and fingers may be recognized or detected by statically combining previously-learnt color and another image feature with the image feature included in the image data as a detection target. Obviously, another method may be used.

An example is described with respect to an image on the palm side of the hand of a user, the GUI member is displayed on the image (front portion) of the palm side, and with respect to an image on the back side, the image on the back side is overlapped on the GUI member and the resultant image is displayed.

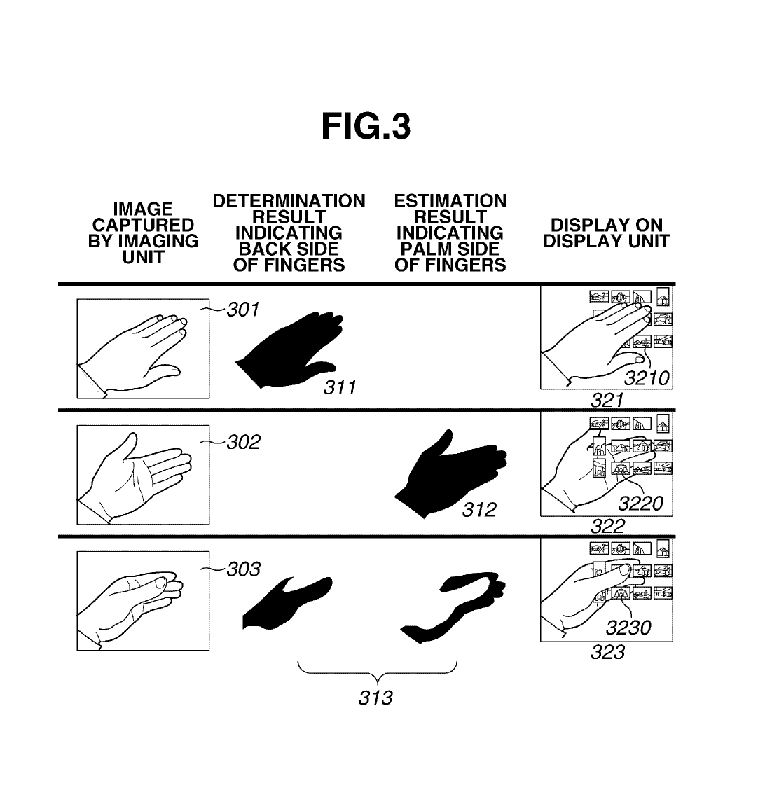

FIG. 3 illustrates examples of images captured by the imaging unit 22, detection results of the fingers on the palm and back sides, and combined images of the image on the palm side, the GUI member, and then image on the backside displayed on the display unit 28. The image processing unit 24 has a function of a combination unit that generates the combined images, and also has a combination function on the program.

Referring to FIG. 3, detected images 311, 312, and 313 illustrate detection results, as monochrome binary images, of the fingers on the palm side and the back side with respect to images 301, 302, and 303 captured by the imaging unit 22. Combined images 321, 322, and 323 are obtained by combining the detected images 311, 312, and 313 and GUI members 3210, 3220, and 3230, and are displayed on the display unit 28.

Thumbnail images of an image file recorded on the recording medium 200 are examples of the GUI members 3210, 3220, and 3230. As will be described below, the thumbnail image is pointed, thereby instructing various processing. For example, the instruction includes the entire-screen display or enlargement display of the image, image advance, selection of a target for printing or processing of slide show, storage to a specific folder with drag and drop, and addition of attribute information such as protection or classification information.

For the captured image 301, the detected image 311 contains an image obtained by detecting only the fingers on the back side. In this case, the combined image 321 is combined so that the image of the fingers is on or in front of the GUI member 3210. That is, the combined image 321 is combined so that the image of the fingers in the captured image 301 partly covers the GUI member 3210.

For the captured image 302, the detected image 312 contains an image obtained by detecting only the fingers on the palm side. In this case, the combined image 322 is combined so that the GUI member 3220 is on (or in front of) the image of the fingers on the palm side.

For the captured image 303, the detected image 313 contains an image obtained by detecting the fingers on both the backside and the palm side. In this case, the combined images 323 is combined so that the GUI member 3230 is overlapped on the image of the fingers on the palm side and the image of the fingers on the back side is overlapped on the GUI member 3230.

In all the combined images 321, 322, and 323, the GUI members 3210, 3220, and 3230 are constantly displayed to come into contact with the palm side of the fingers of the user. Thus, it is possible to give the user the sense of intuitive operation of the GUI member as if the user is touching a real object by the user's hand. This is because people do not use the back side but the palm side to touch the real object.

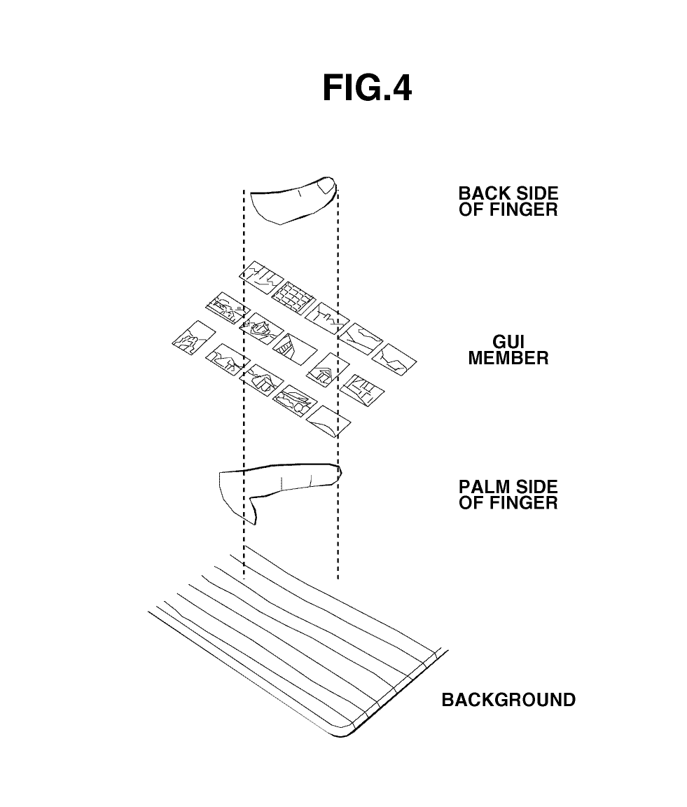

FIG. 4 is a schematic diagram illustrating a method for combining the image of a finger on the palm side, the GUI member, and the image of the thumb on the back side. An upper portion in FIG. 4 represents the front side in the combination and a lower portion represents the back side in the combination. With combination in FIG. 4, it is displayed that the GUI member is over the image of the finger on the palm side, and the image of the thumb on the back side is over the GUI member.

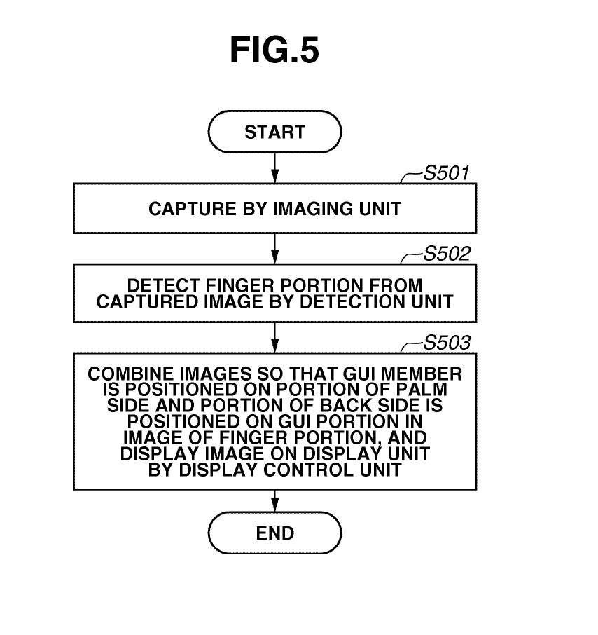

FIG. 5 illustrates a processing flow of combination and display according to the present exemplary embodiment. A finger portion is detected from the captured image. In the image of the finger portion, the GUI member is displayed on the image of the fingers on the palm side and the image of the thumb on the back side on the GUI member, thereby combining the images and displaying the resultant image.

The system controller unit 50 executes a control program recorded on the nonvolatile memory 56, thereby realizing the processing flow in FIG. 5.

Referring to FIG. 5, in step S501, the imaging unit 22 captures an image of fingers as a subject. In step S502, the detection unit detects the finger portion from the captured image. In step S503, the display control unit combines the images so that the GUI member is displayed on the image of the fingers on the palm side and the image of the thumb on the back side is on the GUI member from the image of the finger portion, and displays the obtained combined images on the display unit 28.

A second exemplary embodiment includes an estimation unit for estimating that there is the finger portion within an image capturing area. Specifically, the system controller unit 50 transmits the image data of a detection target to the image processing unit 24. Under the control of the system controller unit 50, the image processing unit 24 detects the finger portion with a well-known method.

The system controller unit 50 compares the detected image with the finger portion detected from the image data one frame before, thereby detecting the change rate in size and the amount of positional change with respect to the finger portion on the back side and the palm side.

When the change rate and the amount of change satisfy predetermined conditions, the system controller unit 50 estimates that there is the finger portion within the image capturing area, outputs positional data indicating the estimated finger portion, and ends the processing.

The skilled person in the technical field of information processing can realize the estimation of the finger portion with a well-known art. For example, there are well-known arts of a differential method using a differential image between a background image and an image of the finger portion and a method for detecting a motion vector of the finger portion. A method discussed in Japanese Patent Application Laid-Open No. 2002-056392 may be used.

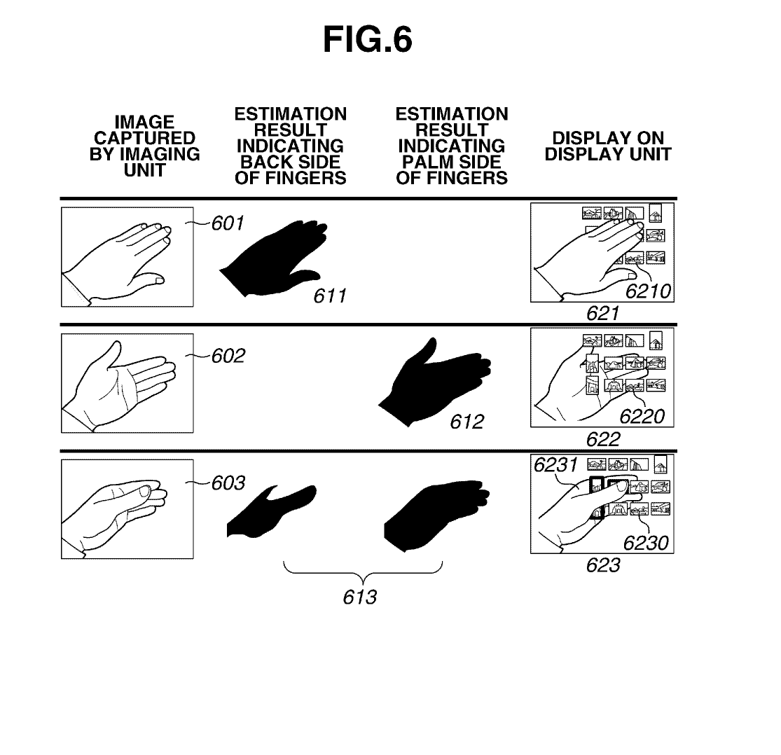

FIG. 6 illustrates display examples according to the present exemplary embodiment. Referring to FIG. 6, images 601, 602, and 603 are captured by the imaging unit 22. Monochrome binary images 611, 612, and 613 illustrate estimation results of the finger portion on the palm side and the back side within the image capturing area, for the images 601, 602, and 603. States 621, 622, and 623 illustrate that it is determined that the user points GUI members that are overlapped on the finger portions on the palm side and the back side and are displayed, and the GUI members are displayed on the display unit 28.

GUI members 6210 and 6220 are not displayed on the overlap portion between the finger portion on the palm side and the thumb portion on the back side. Therefore, the GUI members 6210 and 6220 are not displayed as the GUI members being pointed by the user.

The GUI member 6230 is partly displayed on the overlapped portion of the portion on the palm side and the portion on the back side of the fingers. It is determined that the portion is pointed by the user and the portion is displayed with a selection frame 6231 indicating an operation target.

An apparatus using the GUI detects pointing (pointing operation) of the user to the displayed GUI member, thereby realizing the operation and input by the user to the apparatus. According to the present exemplary embodiment, the operation and input by the user are realized by giving the user the sense of intuitive operation of the GUI member as if the user is touching a real object by the user's hand.

With a computer program employing the GUI, various pointing devices such as a mouse, a stylus pen, or a touch pad can be generally replaced or shared.

With respect to the stylus pen, an input when the pen edge is grounded is connected to an input processing system when performing mouse click with a mouse. According to the present exemplary embodiment, in the case of the input when the finger portions on the palm side of the user is overlapped on the back side portion of the thumb, the input is connected to the similar processing system to that of the input when performing the mouse click with the mouse. Thus, it is possible to easily incorporate the function according to the present exemplary embodiment to a computer program using the mouse.

A third exemplary embodiment includes a nail detection unit for detecting a nail portion of the thumb from the captured image. Since the nail detection is realized by a well-known method, the details are not described.

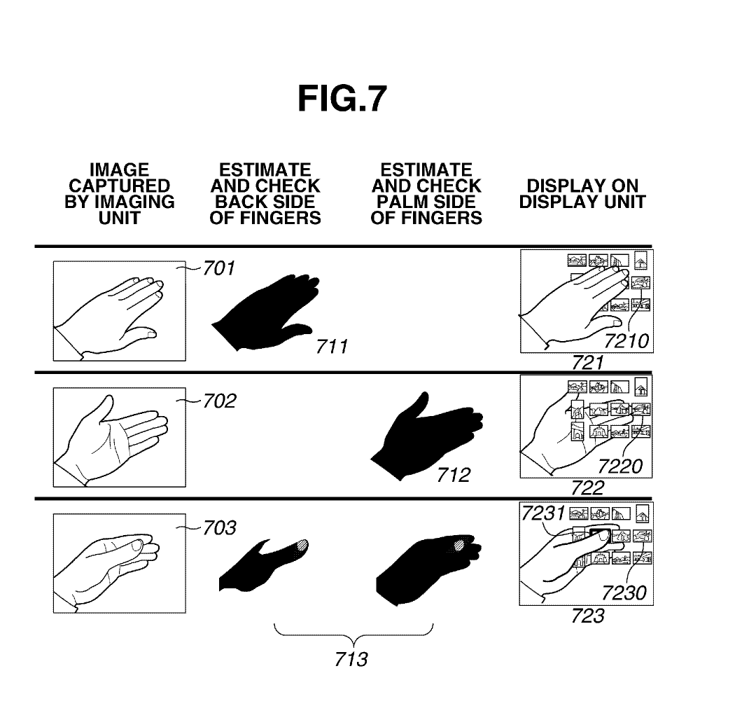

FIG. 7 illustrates display examples according to the present exemplary embodiment. Referring to FIG. 7, images 701, 702, and 703 are captured by the imaging unit 22. Images 711, 712, and 713 illustrate detection results of the portion of the fingers on the palm side, the portion on the backside thereof, and the nail portion, corresponding to the captured images 701, 702, and 703.

FIG. 7 illustrates the detection results of the portion of the fingers on the palm side and the portion thereof on the back side with monochrome binary images, and the detection result of the nail portion with hatching of diagonal lines. States 721, 722, and 723 illustrate the case in which it is determined that the user points the GUI members that are displayed to be overlapped on the portion of the fingers on the palm side and the nail portion of the thumb, and further illustrate that the GUI members are displayed.

The GUI members pointed by the user are displayed on the overlapped portion of the finger portions on the palm side and the nail portion of the thumb. On the other hand, the GUI members that are not pointed by the user are out of the overlapped portion of the portion of the fingers on the palm side and the nail portion of the thumb.

Since GUI members 7210 and 7220 are not displayed on the overlapped portion of the portion of the fingers on the palm side and the nail portion of the thumb, the user does not point the GUI members 7210 and 7220.

On the other hand, a GUI member 7230 is partly displayed on the overlapped portion of the portion of the fingers on the palm side and the nail portion of the thumb. Therefore, the user points the GUI member 7230, and a selection frame 7231 indicating an operation target is simultaneously displayed.

A person generally pinches a real object, particularly, by the fingertip (nail portion). According to the present exemplary embodiment, the sense of operation to pinch the GUI member as if the user is touching a real object by the user's hand is given to the user, thereby enabling the user to feel the intuitive operability.

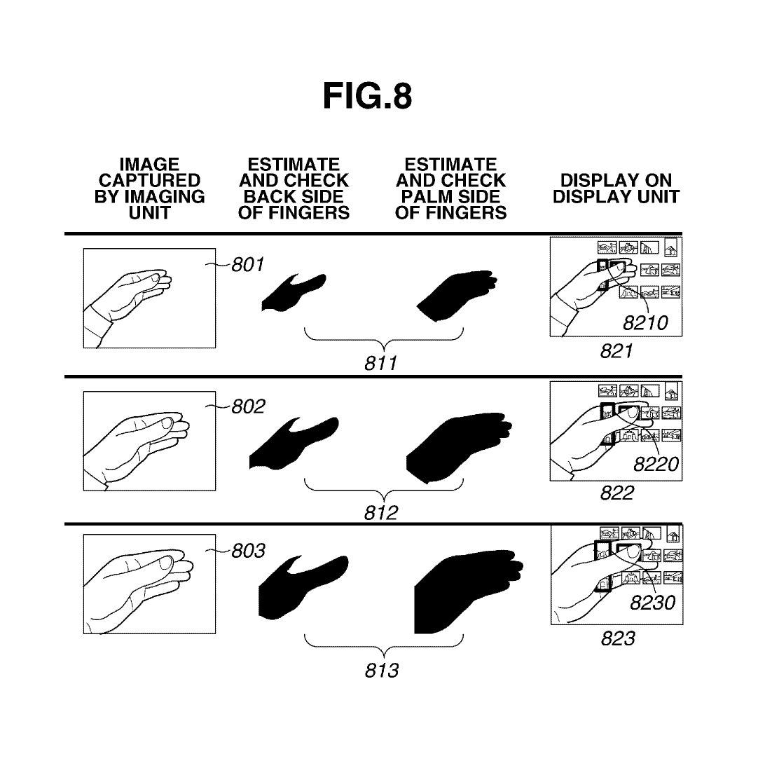

When the user points the GUI member, and the fingers that are being captured are enlarged or reduced, the GUI member desirably is enlarged or reduced to be displayed. FIG. 8 illustrates display examples thereof.

Referring to FIG. 8, images 801, 802, and 803 are captured by the imaging unit 22. Images 811, 812, and 813 illustrate detection results of the portion of the fingers, as monochrome binary data, corresponding to the captured images 801, 802, and 803. States 821, 822, and 823 illustrate the case in which GUI members are displayed overlappingly on the finger portions on the palm side and the portion of the thumb on the back side, and further illustrate that it is determined that the GUI members are pointed by the user and are displayed on the display unit 28.

GUI members 8210, 8220, and 8230 are displayed with enlargement and reduction so that the size rates of the fingers included in the captured images 801, 802, and 803 can be the same with each other.

When the user pulls forward the images of the fingers included in the captured images (i.e., close to the imaging unit 22), the images of the fingers are enlarged. On the other hand, when the user pushes backward the images of the fingers included in the captured images (i.e., apart from the imaging unit 22), the images of the fingers are reduced in size.

By enlarging and reducing the GUI member, similar to the enlargement and reduction of the size of the fingers, it is possible to give the user the sense of operation so that the GUI member is pulled forward or pushed backward according to the motion of the fingers.

With a computer program for managing an object such as a file with a layer, the layer is expressed as a GUI member called a folder. The user moves the layer with GUI operation for opening and closing the folder. Thus, the desired object can be searched.

For the computer program that manages the object with the layer, operations such as “layer down” and “layer up” correspond to the operations “pull forward” and “push backward”. Thus, intuitive operation can be attained.

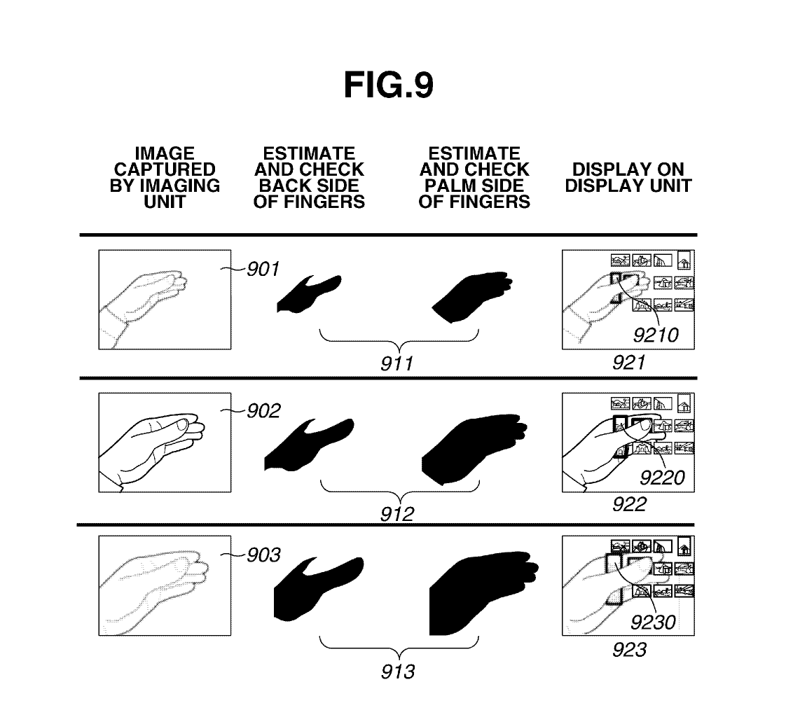

When it is determined that the user points the GUI member, if the fingers being captured are focused, the GUI member is displayed to be in focus. On the other hand, when the fingers being captured are out of focus, the GUI member is displayed to be out of focus. FIG. 9 illustrates display examples thereof.

Referring to FIG. 9, images 901, 902, and 903 are captured by the imaging unit 22. Detected images 911, 912, and 913 illustrate detection results, as monochrome binary images, of the portions of the fingers corresponding to the captured images 901, 902, and 903.

States 921, 922, and 923 illustrate that it is determined that the user points GUI members displayed overlappingly to the portion of the fingers on the palm side and the portion of the thumb on the back side, and further illustrate that the GUI members are displayed on the display unit 28. GUI members 9210, 9220, and 9230 are displayed with the same focusing level as that of the portion of the fingers displayed on the captured images 901, 902, and 903.

The portions of the fingers are detected from the images captured by the imaging unit 22. The portion of the fingers is in focus at specific distance from the imaging unit 22, and the portion of the fingers is not in focus at a portion at the specific distance. That is, when the fingers are pulled forward (i.e., close to the imaging unit 22) or the fingers are pushed backward (i.e., apart from the imaging unit 22), the fingers are blurred on the captured image.

According to the present exemplary embodiment, the GUI member is displayed in the same focusing level as that of the fingers, thereby giving the user the sense to pull forward the GUI member or push backward the GUI member according to the motion of the fingers.

According to the exemplary embodiments, the GUI member generically includes graphic components displayed on the screen to realize a graphical user interface (GUI. The GUI member includes not only the thumbnail image and the selection frame but also, an icon, a button, a check box, a slider, a list box, a spin button, a drop down, a menu, a tool bar, a combination box, a text box, a tab, a scroll bar, a label, and a window.

According to the exemplary embodiments described above, with the hardware member generally provided for the digital camera, the GUI member can be operated with the sense as if the user is touching a real object by the user's hand. That is, a tangible (formless information can be directly touched) operation is possible.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-195856 filed Sep. 1, 2010, which is hereby incorporated by reference herein in its entirety.

What is claimed is:

1. An imaging apparatus comprising:
an imaging unit;
a detection unit configured to detect finger portions from an image captured by the imaging unit; and
a display control unit configured to display, on a display unit, a combined image generated in such a manner that a GUI member is positioned on a finger portion of a palm side and a finger portion of a back side is positioned on the GUI member from the image of the finger portions detected by the detection unit.

2. The imaging apparatus according to claim 1, further comprising:
an estimation unit configured to estimate that there are the finger portions within an image capturing area of the imaging unit; and
a determination unit configured to determine that a user points the GUI member displayed on an overlapped portion of the finger portion on the palm side and the finger portion of the back side in the portion of the fingers estimated by the estimation unit.

3. The imaging apparatus according to claim 1, further comprising:
an estimation unit configured to estimate that the finger portion is included in a image capturing area of the imaging unit;
a nail detection unit configured to detect a nail portion of the finger portion from the image captured by the imaging unit; and
a determination unit configured to determine that a user points the GUI member displayed on an overlapped portion of the finger portion of the palm side and the nail portion of a thumb detected by the nail detection unit from the finger portions estimated by the estimation unit.

4. The imaging apparatus according to claim 2, wherein, when the determination unit determines that the user points the GUI member and the finger portion detected by the detection unit is enlarged or reduced, the display control unit displays the GUI member to be enlarged or reduced according to the finger portion.

5. The imaging apparatus according to claim 2, wherein, when the determination unit determines that the user points the GUI member, the display control unit displays the GUI member with a similar focusing level to that of the finger portion.

6. A control method for an imaging apparatus, comprising:
detecting a finger portions from an image captured by an imaging unit;
combining images generated in such a manner that a GUI member is positioned on a finger portion of a palm side and the finger portion of a back side on the GUI member from the image of the finger portions detected by the detection; and
displaying the combined image on a display unit.

7. A non-transitory recording medium that records a control program for controlling an imaging apparatus, the control program comprising:
detecting a finger portion from an image captured by the imaging apparatus;
generating a combined image such that a GUI member is positioned on a finger portion of the palm side and a finger portion of the back side is positioned on the GUI member from an image of the detected finger portions; and
displaying the combined image on a display unit.
